(19) United States
(12) Patent Application Publication
(10) Pub. No.: US 2020/0166165 A1
(43) Pub. Date: May 28, 2020

(54) CLAMP LOCATOR AND HOSE CLAMP HAVING THE SAME

(71) Applicants: HYUNDAI MOTOR COMPANY, Seoul (KR); KIA MOTORS CORPORATION, Seoul (KR); YUSHIN PRECISION INDUSTRIAL CO., LTD, Incheon (KR)

(72) Inventors: Hyo Chul Kim, Seoul (KR); Jin Sung Park, Bucheon-si (KR); Hyun Mu Lee, Incheon (KR); Si Hyun Cho, Incheon (KR)

(73) Assignees: HYUNDAI MOTOR COMPANY, Seoul (KR); KIA MOTORS CORPORATION, Seoul (KR); YUSHIN PRECISION INDUSTRIAL CO., LTD, Incheon (KR)

(21) Appl. No.: 16/516,040

(22) Filed: Jul. 18, 2019

(30) Foreign Application Priority Data
Nov. 27, 2018 (KR) 10-2018-0148686

(51) Int. Cl. F16L 33/04

(52) U.S. Cl. CPC F16L 33/04

(57) ABSTRACT

A clamp locator includes: a body having an attachment portion, which is attached to a band of a hose clamp; a head portion extending from the body; an end portion extending angularly from the head portion; a clip portion bendably connected to the end portion; and an engaging portion extending angularly from the clip portion and having a plurality of teeth. The attachment portion has at least one projection, which is meltable.

### CROSS-REFERENCE TO RELATED APPLICATION

This application is based on and claims the benefit of priority to Korean Patent Application No. 10-2018-0148686, filed on Nov. 27, 2018, in the Korean Intellectual Property Office, the disclosure of which is incorporated herein in its entirety by reference.

### TECHNICAL FIELD

The present disclosure relates to a clamp locator, and more particularly, to a clamp locator, which is very easily attachable to a hose clamp, is attached to various locations of the hose clamp, and is capable of accurately and conveniently setting the location of the hose clamp near an end of a hose. The present disclosure also relates to a hose clamp having the same.

### BACKGROUND

A hose clamp may be used to tightly clamp a hose to a pipe. The hose clamp may include a band surrounding the hose and a tightening mechanism disposed on one side of the band.

The hose clamp may be fixedly positioned by a fixing pad at a predetermined distance from the end of the hose. The fixing pad may be attached to the hose clamp using a jig and a bond.

However, an existing hose clamp requires a process of attaching the fixing pad using the bond, making the manufacturing process complicated, and increasing the manufacturing cost.

In addition, since the fixing pad is vulnerable to heat from the outside, the fixing pad may easily be detached from the hose clamp during transportation.

### SUMMARY

The present disclosure has been made to solve the above-mentioned problems occurring in the prior art while advantages achieved by the prior art are maintained intact.

An aspect of the present disclosure provides a clamp locator, which is very easily attachable to various locations of a hose clamp. The clamp locator is capable of accurately and conveniently setting the location of the hose clamp near an end of a hose. Another aspect of the present disclosure provides a hose clamp having the same.

According to an aspect of the present disclosure, a clamp locator allows a hose clamp to be positioned in a location spaced apart from an end surface of a hose The clamp locator may include: a body having an attachment portion, which is attached to a band of the hose clamp; a head portion extending from the body; an end portion extending angularly from the head portion; a clip portion bendably connected to the end portion; and an engaging portion bendably connected to the clip portion, and having a plurality of teeth. The attachment portion may have at least one projection, which is meltable.

The attachment portion may be vertically offset with respect to a bottom of the body by a first offset distance.

The first offset distance may be defined to be a vertical distance between the attachment portion and the bottom of the body.

The head portion may be vertically offset with respect to a bottom of the body by a second offset distance.

The second offset distance may be defined to be a vertical distance between the head portion and the bottom of the body.

A first stopper may vertically extend between the head portion and a bottom of the body and the first stopper may contact the band of the hose clamp.

The clip portion may have a through hole.

The head portion may include a second stopper capable of contacting the end surface of the hose.

According to another aspect of the present disclosure, a hose clamp may include: a band surrounding a hose; a tightening mechanism disposed on one side of the band; and a clamp locator attached to the band and allowing the band to be positioned in a location spaced apart from an end surface of the hose. The clamp locator may include a body having an attachment portion, which is attached to the band of the hose clamp, a head portion extending from the body, an end portion extending angularly from the head portion, a clip portion bendably connected to the end portion, and an engaging portion extending angularly from the clip portion. The attachment portion may have at least one projection, which is meltable.

The head portion may have a contact surface contacting an exterior surface of the hose and the contact surface of the head portion may be flush with an interior surface of the band.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a perspective view of a hose clamp according to an embodiment of the present disclosure;

FIG. 2 illustrates a view in a direction of arrow A of FIG. 1;

FIG. 3 illustrates a perspective view of a clamp locator according to an embodiment of the present disclosure;

FIG. 4 illustrates a side cross-sectional view of a clamp locator according to an embodiment of the present disclosure;

FIG. 5 illustrates a state in which a band of a hose clamp according to an embodiment of the present disclosure is positioned around a hose by a clamp locator;

FIG. 6 illustrates a side cross-sectional view of a clamp locator according to another embodiment of the present disclosure; and

FIG. 7 illustrates a state in which a band of a hose clamp according to another embodiment of the present disclosure is positioned around a hose by a clamp locator.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been excluded in order not to unnecessarily obscure the gist of the present disclosure.

Terms such as first, second, A, B, (a), and (b) may be used to describe the elements in embodiments of the present disclosure. These terms are only used to distinguish one element from another element. The intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

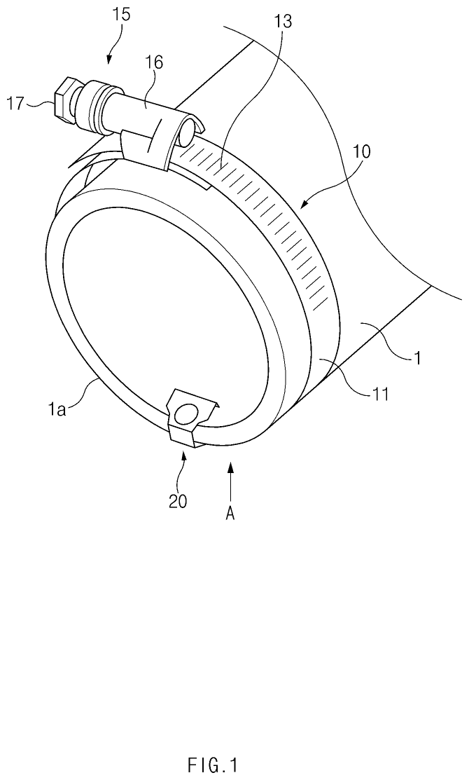

Referring to FIG. 1, a hose clamp 10 according to an embodiment of the present disclosure may include a band 11 surrounding a hose 1, a tightening mechanism 15 disposed on one side of the band 11, and a clamp locator 20 fixed to the band 11.

Both end portions of the band 11 may be overlapped with each other and the tightening mechanism 15 may be disposed on the overlapped end portions of the band 11. The band 11 may be tightened by the tightening mechanism 15.

According to an embodiment, the tightening mechanism 15 may be a worm gear clamp having a housing 16 fixed to one end portion of the band 11 and a worm screw 17 movably received in the housing 16. A plurality of slots 13 may be formed in the other end portion of the band 11 and the worm screw 17 may mesh with the plurality of slots 13.

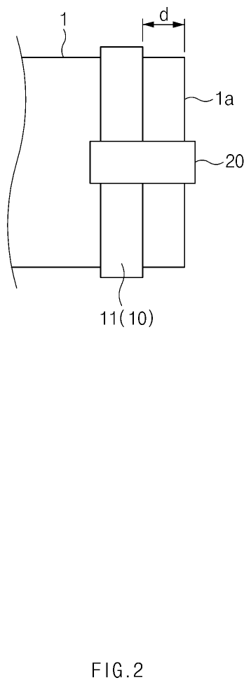

Referring to FIG. 2, the clamp locator 20 may allow the band 11 of the hose clamp 10 to be accurately positioned in a location spaced apart from an end surface 1a of the hose 1 by a predetermined distance d.

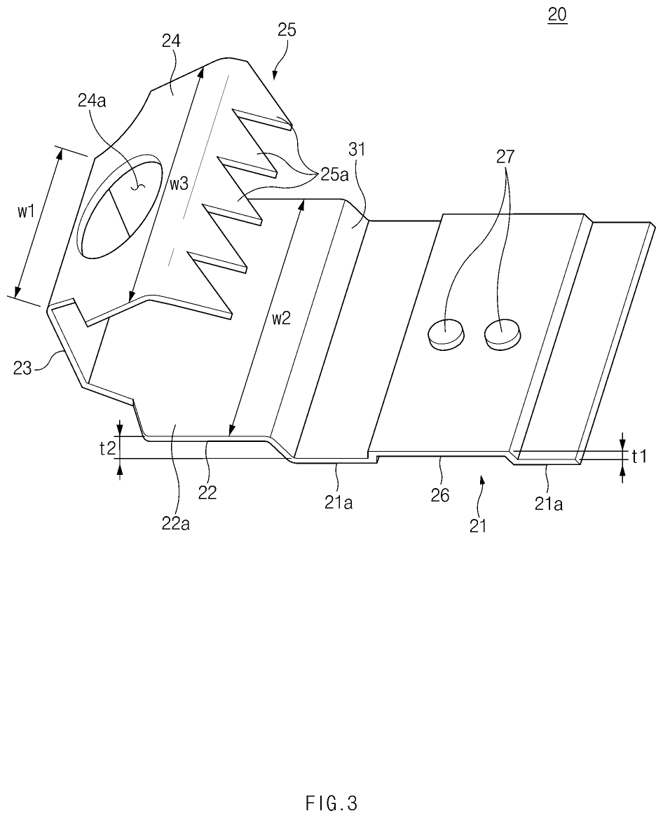

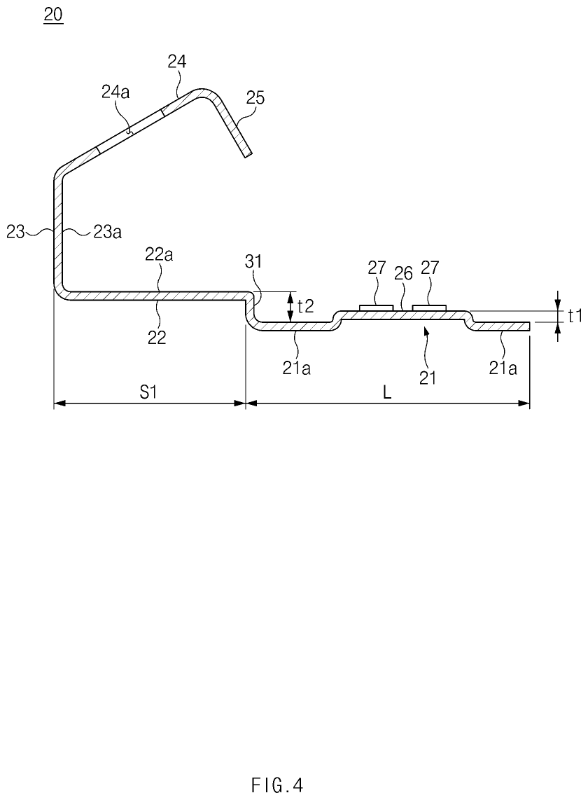

Referring to FIGS. 3-5, the clamp locator 20 may include a body 21 attached to the band 11 of the hose clamp 10, a head portion 22 extending from the body 21, an end portion 23 extending angularly from the head portion 22, a clip portion 24 extending angularly from the end portion 23, and an engaging portion 25 extending angularly from the clip portion 24.

The body 21 may be substantially planar or slightly rounded to match a radial or circumferential curved shape of the band 11.

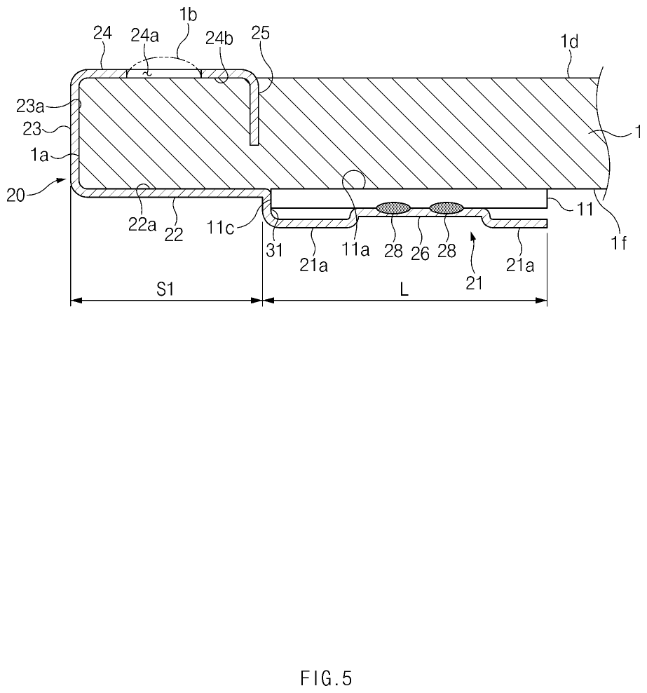

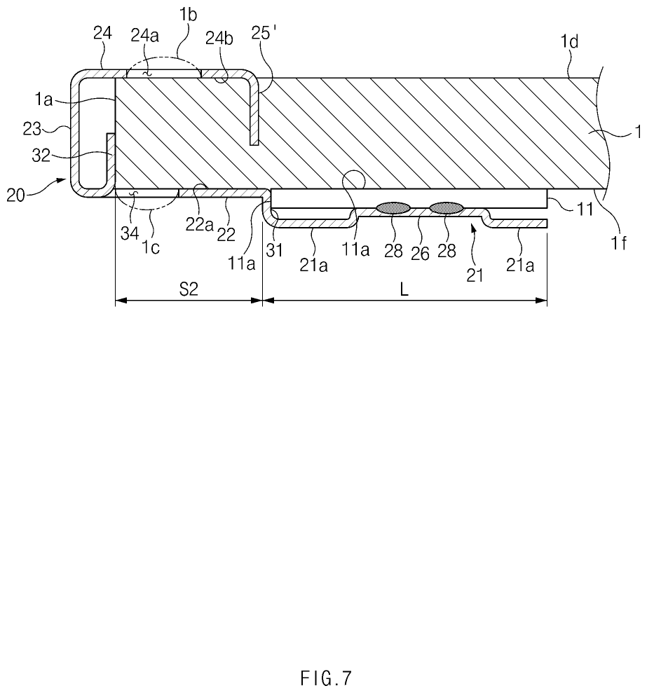

According to an embodiment, the body 21 may have an attachment portion 26 attachable to various locations of the band 11 by welding. The attachment portion 26 may have one or more projections 27, which are melted by heat and pressure. For example, the one or more projections 27 may be melted by resistance projection welding so that the attachment portion 26 may be attached to an exterior surface of the band 11. The projections 27 may be provided on the attachment portion 26 of the body 21 to protrude toward the band 11. The projections 27 may be melted by heat and pressure to define a weld nugget site 28 on faying surfaces between the attachment portion 26 and the band 11, as illustrated in FIGS. 5 and 7. Due to the melting of the projections 27, the attachment portion 26 of the body 21 may be firmly welded to the band 11.

According to an embodiment, the attachment portion 26 may be disposed on a central portion of the body 21. The attachment portion 26 may be vertically offset with respect to a bottom 21a of the body 21 by a first offset distance t1. The first offset distance t1 may be arbitrarily defined to be a vertical distance between the attachment portion 26 and the bottom 22a of the body 21. Since the attachment portion 26 is raised from the body 21, stiffness and strength of the body 21 may be improved. The attachment portion 26 may have a relatively narrow area compared to the entire area of the body 21 to allow welding electrodes to be accurately and easily positioned on the attachment portion 26 so that the welding operation may be performed quickly and accurately.

The head portion 22 may extend flat from the body 21 and the head portion 22 may have a contact surface 22a contacting an exterior surface if of the hose 1. The head portion 22 may be substantially planar or slightly rounded to match a radial or circumferential curved shape of the hose 1.

The head portion 22 may be vertically offset with respect to the bottom 21a of the body 21 by a second offset distance t2. The second offset distance t2 may be arbitrarily defined to be a vertical distance between the head portion 22 and the bottom 22a of the body 21.

In a state in which the attachment portion 26 of the body 21 is attached to the exterior surface of the band 11, the contact surface 22a of the head portion 22 may be flush with an interior surface 11a of the band 11. In other words, a thickness of the band 11 may be the same as the second offset distance t2, which ensures the flatness of the hose 1. Thus, the hose 1 may be more tightly clamped to a pipe (not shown) by the hose clamp 10.

A first stopper 31 may vertically extend between the head portion 22 and the bottom 22a of the body 21. As illustrated in FIG. 5, the first stopper 31 may contact one end or edge 11c of the band 11 so that the clamp locator 20 may be accurately positioned with respect to the band 11. In a state in which the clamp locator 20 is positioned with respect to the band 11 by the first stopper 31, the attachment portion 26 of the body 21 may be attached to the band 11 by welding or the like.

The end portion 23 may extend angularly from the head portion 22. For example, the end portion 23 may be orthogonal to the head portion 22. One end of the end portion 23 may be connected to the head portion 22 and the other end of the end portion 23 may be connected to the clip portion 24. The end portion 23 may have a length that is sufficient to allow the end surface 1a of the hose 1 to be positioned between the head portion 22 and the clip portion 24. For example, the length of the end portion 23 may be similar or slightly smaller than that of the end surface 1a of the hose 1.

According to an embodiment, the end portion 23 may have an interior surface 23a facing the end surface 1a of the hose 1. As illustrated in FIG. 5, the interior surface 23a of the end portion 23 may contact the end surface 1a of the hose 1 so that the band 11 of the hose clamp 10 may be positioned to be spaced apart from the end surface 1a of the hose 1 by a first distance S1 between the end portion 23 and the first stopper 31.

The clip portion 24 may extend angularly from the end portion 23, and the clip portion 24 may be bendably connected to the end portion 23. The clip portion 24 may have a contact surface 24b contacting an interior surface 1d of the hose 1. The clip portion 24 may be substantially planar or slightly rounded to match the radial or circumferential curved shape of the hose 1.

According to an embodiment, as illustrated in FIG. 3, a width w1 of the end portion 23 may be less than a width w2 of the head portion 22 and a width w3 of the clip portion 24. A portion of the head portion 22 connected to one end of the end portion 23 may have a reduced width and a portion of the clip portion 24 connected to the other end of the end portion 23 may have a reduced width. Thus, the clip portion 24 may be more easily bendable with respect to the end portion 23.

The engaging portion 25 may extend angularly from the clip portion 24 and the engaging portion 25 may be bendably connected to the clip portion 24. For example, the engaging portion 25 may be orthogonal to the clip portion 24. The engaging portion 25 may have a plurality of teeth 25a. As illustrated in FIG. 5, the clip portion 24 may be bent toward the hose 1 so that the plurality of teeth 25a may be engaged to the interior surface of the hose 1.

According to an embodiment, the clip portion 24 may have a through hole 24a. As illustrated in FIG. 5, as the engaging portion 25 is engaged to the interior surface of the hose 1, the clip portion 24 may press the interior surface of the flexible hose 1. Accordingly, a portion of the hose 1 may be deformed (expanded) toward the through hole 24a, and the deformed portion 1b of the hose 1 may be inserted into the through hole 24a. Thus, the clamp locator 20 may be more firmly coupled to the end portion of the hose 1.

As illustrated in FIG. 5, as the first stopper 31 of the clamp locator 20 contacts the end or edge 11c of the band 11 of the hose clamp 10, the body 21 of the clamp locator 20 may be accurately positioned with respect to the band 11. The attachment portion 26 of the body 21 may be firmly attached to the band 11 of the hose clamp 10 by melting the projections 27 by resistance projection welding.

After the clamp locator 20 is attached to the band 11 of the hose clamp 10, the end surface 1a of the hose 1 may contact the interior surface 23a of the end portion 23 and the engaging portion 25 of the clamp locator 20 may be engaged to the hose 1. Thus, the band 11 of the hose clamp 10 may be accurately positioned in a location spaced apart from the end surface 1a of the hose 1.

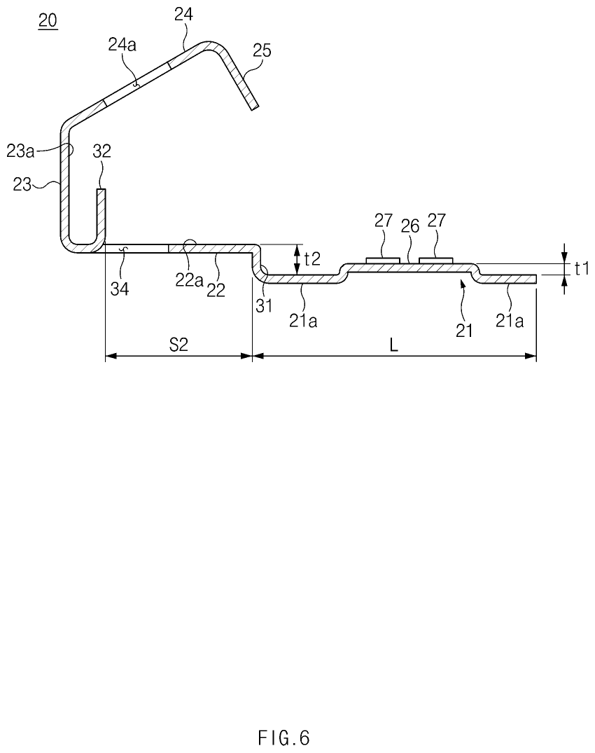

FIGS. 6 and 7 illustrate a clamp locator according to another embodiment of the present disclosure.

According to another embodiment of the present disclosure, the head portion 22 may further include a second stopper 32 capable of contacting the end surface 1a of the hose 1.

The second stopper 32 may be formed to stand upright on a portion of the head portion 22 by lancing. Accordingly, a lanced opening 34 having the same shape as that of the second stopper 32 may be formed in the portion of the head portion 22 adjacent to the second stopper 32. Meanwhile, when the second stopper 32 is not used, the second stopper 32 may be bent to be received in the opening 34.

The second stopper 32 may protrude toward the clip portion 24 and the second stopper 32 may be parallel to the end portion 23. The second stopper 32 may be horizontally spaced apart from the first stopper 31 by a second distance S2.

As illustrated in FIG. 7, the engaging portion 25 may be engaged to the hose 1 in a state in which the end surface 1a of the hose 1 contacts the second stopper 32, so that the band 11 of the hose clamp 10 may be positioned in a location spaced apart from the end surface 1a of the hose 1 by the second distance S2 between the first stopper 31 and the second stopper 32.

As the engaging portion 25 is engaged to the hose 1, the clip portion 24 may press the interior surface of the flexible hose 1 and the head portion 22 may press the exterior surface of the flexible hose 1. Accordingly, portions of the hose 1 may be deformed (expanded) toward the through hole 24a and the opening 34. The deformed portions 1b and 1c of the hose 1 may be inserted into the through hole 24a and the opening 34. Thus, the clamp locator 20 may be more firmly coupled to the end portion of the hose 1.

As set forth above, the clamp locator, according to embodiments of the present disclosure, may be very easily attachable to the hose clamp, be attached to various locations of the hose clamp, and be capable of accurately and conveniently setting the location of the hose clamp near the end of the hose.

Hereinabove, although the present disclosure has been described with reference to embodiments and the accompanying drawings, the present disclosure is not limited thereto. The embodiments may be variously modified and altered by those having ordinary skill in the art to which the present disclosure pertains without departing from the spirit and scope of the present disclosure claimed in the following claims.

What is claimed is:

1. A clamp locator, which allows a hose clamp to be positioned in a location spaced apart from an end surface of a hose, the clamp locator comprising:
a body having an attachment portion, which is attached to a band of the hose clamp;
a head portion extending from the body;
an end portion extending angularly from the head portion;
a clip portion bendably connected to the end portion; and
an engaging portion bendably connected to the clip portion and having a plurality of teeth,
wherein the attachment portion has at least one projection, which is meltable.

2. The clamp locator according to claim 1, wherein the attachment portion is vertically offset with respect to a bottom of the body by a first offset distance.

3. The clamp locator according to claim 2, wherein the first offset distance is defined to be a vertical distance between the attachment portion and the bottom of the body.

4. The clamp locator according to claim 1, wherein the head portion is vertically offset with respect to a bottom of the body by a second offset distance.

5. The clamp locator according to claim 4, wherein the second offset distance is defined to be a vertical distance between the head portion and the bottom of the body.

6. The clamp locator according to claim 1, wherein a first stopper vertically extends between the head portion and a bottom of the body, and
the first stopper contacts the band of the hose clamp.

7. The clamp locator according to claim 1, wherein the clip portion has a through hole.

8. The clamp locator according to claim 1, wherein the head portion includes a second stopper capable of contacting the end surface of the hose.

9. A hose clamp, comprising:
a band surrounding a hose;
a tightening mechanism disposed on one side of the band; and
a clamp locator attached to the band and allowing the band to be positioned in a location spaced apart from an end surface of the hose,
wherein the clamp locator includes a body having an attachment portion, which is attached to the band of the hose clamp, a head portion extending from the body, an end portion extending angularly from the head portion, a clip portion bendably connected to the end portion, and an engaging portion extending angularly from the clip portion, and
wherein the attachment portion has at least one projection which is meltable.

10. The hose clamp according to claim 9, wherein the head portion has a contact surface contacting an exterior surface of the hose, and
wherein the contact surface of the head portion is flush with an interior surface of the band.
